(19) United States
(12) Patent Application Publication
(10) Pub. No.: US 2025/0218158 A1
(43) Pub. Date: Jul. 3, 2025

(54) Device And Method For Classifying Parts

(71) Applicant: NSTITUTO TECNOLÓGICO DE INFORMÁTICA, Paterna (ES)

(72) Inventors: Javier Pérez Soler, Paterna (ES); Juan Carlos Pérez Cortés, Valencia (ES)

(21) Appl. No.: 18/989,728

(22) Filed: Dec. 20, 2024

(30) Foreign Application Priority Data
Dec. 27, 2023 (EP) 23383386.2

(51) Int. Cl. G06V 10/764; G06T 7/194

(52) U.S. Cl. CPC G06V 10/764; G06T 7/194

(57) ABSTRACT

The present invention relates to a device for classifying parts in accordance with a specific part model with a known three-dimensional shape. The present invention also relates to a method for carrying out such classification. As a result of the classification, the device and the method are capable of determining whether a specific part corresponds to one of the models taken as a reference.

### CROSS-REFERENCE TO RELATED APPLICATION

This application claims priority to European Patent Application No. 23383386.2 filed on Dec. 27, 2023, the disclosure of which is hereby incorporated by reference.

### OBJECT OF THE INVENTION

The present invention relates to a device for classifying parts in accordance with a specific part model with a known three-dimensional shape. The present invention also relates to a method for carrying out such classification. As a result of the classification, the device and the method are capable of determining whether a specific part corresponds to one of the models taken as a reference.

More particularly, the invention is characterized by the capacity to classify a part by means of cameras which capture images of said part without the part having to adopt a specific position. Therefore, the device and the method of the invention use these cameras to acquire images of the part from different points of view and a processor in charge of analyzing said images to classify the part among several part models with a known three-dimensional shape.

### BACKGROUND OF THE INVENTION

Classification of parts based on an image taken by a camera in accordance with different part models with a known shape is not sufficient when the parts are very similar to one another morphologically or when the part belongs to a set in which a single view is never capable of differentiating between the different parts of said set; for example, a part comprising a plurality of faces with one and the same drawing on each face, but with the drawing exhibiting a different distribution on each of said faces.

On one hand, due to the nature of the part to be captured by the camera and to lighting conditions, it is possible that the only information available for classification is the contour. This contour information is often insufficient to distinguish between two or more parts, particularly when the parts exhibit significant morphological similarity. In such cases, when the parts are in a certain position, the contours thereof captured by the camera may be substantially the same and, therefore, the classification of the parts may not be very precise.

Other morphological or appearance characteristics of the parts could be used for classification, but it is not always possible to use them. For example, the texture of the part may be contaminated, so classification based on this characteristic would not have the required accuracy either. Similarly, shadows and reflections on the parts can help to estimate the geometry or three-dimensional shape of the parts, but said shadows and reflections can be highly attenuated, for example when using polarized light, precisely due to the behavior of the polarized light when it strikes and is reflected on a surface, so classification based on this characteristic would not have a high accuracy in this context either.

There is therefore a need for a device and a method that can classify parts in accordance with different reference part models with high accuracy, even when the parts exhibit significant morphological similarity to one another and the lighting conditions do not necessarily provide information about the geometry or three-dimensional shape of the part.

### SUMMARY OF THE INVENTION

The present invention proposes a solution to the preceding problems by means of a device for classifying parts according to claim 1 and a method for classifying parts according to claim 15. The dependent claims define preferred embodiments of the invention.

In a first inventive aspect, the invention provides a device for classifying parts, comprising:
a plurality of cameras Cⱼ, j=1, . . . , n, with n being the number of cameras, for capturing images, each of the cameras Cⱼ being configured to capture the part to be classified; wherein the n cameras are distributed in space with a different position and orientation,
a processor configured to receive the images captured by the plurality of cameras Cⱼ and to process them;
wherein the processor is further configured to carry out the following steps:
   a) activating the plurality of cameras with each camera Cⱼ capturing an image of the part to be classified;
   b) segmenting the images in order to distinguish, in each image, the captured part to be classified from the background;
   c) defining a characteristic function ƒ(t), with t being a scalar parameter, of the captured part for each of the segmented images;
   d) comparing, for each segmented image, the characteristic function ƒ(t) with a plurality of predefined reference characteristic functions ƒₘ(t) of a representative model of the part to be classified, determining a degree of proximity with each of such characteristic functions ƒₘ(t);
wherein the reference characteristic functions ƒₘ(t) are predefined according to the following steps:
   i. providing the representative model of the part to be classified;
   ii. selecting a set of orientation angles of the model;
   iii. discretizing a domain formed by all the possible values of the angles selected in the preceding step and, for each point of the discretized domain, orienting the part of the model according to the discrete values of the angles corresponding to that point of the domain;
   iv. generating an image of the model for each orientation established in the preceding step, the image being in accordance with the position and orientation of a camera Cᵢ considered as a reference camera, and executing, for each orientation, steps b) and c) to obtain the characteristic function ƒₘ(t);
and wherein the processor is further configured to:
   e) generate, for each camera Cⱼ, j=1, . . . , n, a scalar function gⱼ dependent on at least the angles selected in step ii), the scalar function gⱼ being defined as the degree of proximity between the characteristic function ƒⱼ(t) of the part captured by the camera Cⱼ and the plurality of reference characteristic functions ƒₘ(t), the scalar function gⱼ being determined in the predefined domain for each angle of the selected angles;
   f) take one of the scalar functions gᵢ, the one associated with a predetermined reference camera Cᵢ, as a reference, and rotating the remaining scalar functions gⱼ, i≠j, according to the orientation difference between the reference camera Cᵢ and the camera Cⱼ so that all the scalar functions are representing the degree of proximity with respect to one and the same angle reference;
   g) merge the n scalar functions gⱼ into a single scalar function gₐ by means of a pre-established merging criterion;
   h) repeat steps d)-g) for a plurality of representative models of the part to be classified obtaining a plurality of scalar functions gₐ;
   i) select the model the scalar function gₐ of which exhibits the minimum degree of proximity from among all the degrees of proximity of the plurality of scalar functions gₐ; and
   j) classify the part as corresponding to the model selected in the preceding step.

The device of the invention seeks to classify a part in accordance with a part model with a known geometry or shape, distinguishing the shape of the model from several different part models. That is, as a result of the classification, the method and the device carrying out the method establish which reference model has the shape closest to the shape of the part to be classified.

Throughout the document, a part shall be understood as an object or a portion of an object. Throughout the document, “part of the model” or simply “model” shall be understood as synonyms.

The device comprises a plurality of cameras Cⱼ for capturing images of the part to be classified. Said cameras Cⱼ are distributed in space with different positions and orientations, so that the part can be seen from different points of view in each of the images. Preferably, each of the cameras Cⱼ has a field of view comprising a region common for all the cameras, this common region being where the part is located at the time of capturing the image.

The device further comprises a processor which activates the cameras Cⱼ and receives and processes the images to extract the information required for classifying the parts.

First, the processor performs a segmentation of the part with respect to the background. Throughout the document, segmentation shall be understood as a computing operation in which two or more regions in a digital image are distinguished. In particular, the processor segments the image to distinguish the part from the background. As a result of segmentation, at least the boundary between the region of the image showing the part and the region of the image corresponding to the background is defined.

For each of the segmented images, the processor defines a characteristic function ƒ(t) of the captured part. This characteristic function ƒ(t) defines a particular characteristic of the captured part, for example, the contour or the texture. In these cases, the characteristic function ƒ(t) is dependent on the contour or on the texture of the part.

The device has stored internally a plurality of reference characteristic functions ƒₘ(t). Said functions define a particular characteristic of the parts with a known shape which are represented by the different models; for example, the contours or the textures of said parts. In these cases, the reference characteristic functions ƒₘ(t) are dependent on the contour or on the texture of these parts of the models.

Therefore, in an operating mode, the processor determines a characteristic function ƒ(t) of the part to be classified which can be calculated according to how such characteristic function is defined. This same operation of determining the characteristic function, and with the same definition, is applied to the plurality of parts of the models in order to obtain the plurality of reference characteristic functions ƒₘ(t).

When expressions such as “parts of models” or simply “models” are used, these expressions can be interpreted to mean that they can be either physical parts which can be captured by means of a camera, giving rise to an image, or virtual models on which it is also possible to generate an image through simulation by placing a virtual camera with the same intrinsic and extrinsic parameters as the actual camera of the device in the same position and orientation with which the image would be taken when the part is real.

The processor has previously generated each of this plurality of reference characteristic functions ƒₘ(t) following the subsequent steps:
i. providing a representative model of the part;
ii. selecting a set of orientation angles of the model;
iii. discretizing a domain formed by all the possible values of the angles selected in the preceding step and, for each point of the discretized domain, orienting the part of the model according to the discrete values of the angles corresponding to that point of the domain;
iv. generating an image of the model for each orientation established in the preceding step, the image being in accordance with the position and orientation of a camera Cᵢ considered as a reference camera;
v. segmenting the generated images to distinguish the part represented by the model from the background; and
vi. defining the reference characteristic function ƒₘ(t) for the part represented by the model.

That is, for each of the images, there is provided a reference characteristic function ƒₘ(t) which is processed as a parametrized signal in a variable.

The processor is further configured to receive the signals defined based on the characteristic functions ƒ(t) of the segmented images of the parts to be classified. The processor compares said signals with the plurality of signals represented by means of the reference characteristic functions ƒₘ(t). This comparison allows determining a degree of proximity between the signals; that is, the processor estimates how similar are the characteristics of the part to be classified and the characteristics of the parts with a known shape which are represented by the different models.

The signals processed by the processor in the form of functions ƒ(t) and ƒₘ(t), respectively, are compared under a specific pre-established closeness criterion. This closeness criterion is not unique. For example, predefining a scalar product and its associated norm is sufficient. The norm of the difference between f(t) and fₘ(t) is an example of the distance measurement between both functions.

In the context of the invention, the greater the similarity between the characteristics of the part to be classified and the characteristics of the parts of the models, the smaller the degree of proximity is in terms of measurement. Therefore, if the degree of proximity is zero, it means that the characteristic functions that are being compared are the same and, therefore, the morphologies of the parts being compared are substantially the same.

Based on the degrees of proximity determined, the processor generates a scalar function gⱼ which depends on the angles selected by the processor to generate the reference characteristic functions ƒₘ(t) (step ii). Therefore, the scalar function gⱼ represents the degree of proximity between the characteristic function ƒⱼ(t) of the part captured by the camera Cⱼ and the plurality of reference characteristic functions ƒₘ(t). When the comparison is made with a plurality of reference characteristic functions ƒₘ(t), it is understood that the distance is measured with each of the reference characteristic functions.

Once the scalar functions gⱼ have been obtained for all the images acquired by the cameras, the processor merges all the collected information such that the classification is based on said merging of information.

The merging process is as described below. First, the processor selects one of the scalar functions gᵢ, the one associated with the reference camera Cᵢ, as a reference, and performs a rotation of the remaining scalar functions. Said rotation depends on the orientation difference between the reference camera Cᵢ and the camera to which the scalar function to be rotated would correspond. The purpose of these rotations of reference functions is so that all of them represent the degree of proximity with respect to one and the same angle reference.

Rotation of a scalar function gᵢ should be interpreted in the following manner. A scalar function gᵢ has a domain, wherein each independent variable on said domain corresponds to a different angle, for example the angle of rotation with respect to a coordinate axis. The range of each angle is different according to the orientation of the camera. The change in orientation which allows expressing the scalar function gᵢ in the “rotated” domain consists of establishing a correspondence, such that the function, for each angle of the domain after the rotation or change in orientation, takes the value of the function before the rotation but acquired in another location of the domain, i.e., in the location of the domain before rotation where the angles taken as an argument are the same.

In one embodiment, the device has stored therein the orientations of the cameras as a result of a prior calibration process.

The processor then merges the scalar functions into a single scalar function gₐ. Each value of the merged scalar function is achieved following a particular pre-established merging criterion; for example, by selecting the maximum value or the mean of the values of the scalar functions to be merged.

Once the scalar function gₐ has been obtained, the processor repeats steps d)-g) for each of the available part models, therefore obtaining a plurality of scalar functions gₐ.

Finally, the processor classifies the part in accordance with the model the scalar function gₐ of which exhibits the minimum degree of proximity from among all the degrees of proximity of the plurality of scalar functions gₐ.

Advantageously, the processor merges all the information available for the classification obtained from the different points of view, such that classification accuracy is maximized.

In one embodiment, the processor is further configured to determine the set of angles which determine the minimum of the scalar function gₐ of the selected model such that the orientation for which the scalar function is minimum is the orientation of the part.

Determination of the minimum of the scalar function gₐ is expected to occur in a location of the domain where the comparison with a model renders the minimum distance and this will occur when the model is the most similar, but also has the orientation closest to the part capturing orientation. Hence, the search for minimum must be performed in the entire domain of the scalar function gₐ.

Therefore, advantageously, the device of the invention not only classifies the part in accordance with a predetermined model, but also estimates the orientation of the part with respect to the actual capturing device.

In one embodiment, if the smallest degree of proximity is greater than a pre-established threshold value, then it is considered that the part to be classified does not correspond to any model, given that there is no model and orientation of said model considered to have a close correspondence with the part captured with any of the cameras.

Therefore, to prevent parts with an unknown morphology from being able to be classified in accordance with the predetermined reference models representing parts with known shapes, the device of the invention contemplates the option of imposing a threshold value above which the part would be considered as not being similar enough to the parts which are represented by the models.

In one embodiment, step c) of defining the characteristic function ƒ(t) and/or the reference characteristic functions ƒₘ(t) comprises the following sub-steps:
c.1) establishing a closed path which delimits the contour of the part in each of the segmented images;
c.2) determining a characteristic point of the closed path, preferably the centroid of the inner area of the closed path;
c.3) selecting an initial point of the closed path;
c.4) parametrizing the closed path based on the selected initial point; and
c.5) defining the characteristic function ƒ(t) or the reference characteristic function ƒₘ(t) as the function which represents, for each parametrized point t of the closed path, the distance between point t and the characteristic point.

In this embodiment, the characteristic function ƒ(t) or the reference characteristic functions ƒₘ(t) are determined based on the contour of the segmented part in the image in order to determine the boundary curve (of the part or of the part represented by the model). In particular, the contour of the part is coded as a one-dimensional signal using the distance to a point inside the closed path, preferably the centroid or geometrical center of the inner area of the closed path. This signal is preferably processed in a discrete manner by taking samples at regular intervals of the closed path.

In one embodiment, step c) of defining the characteristic function ƒ(t) and/or the reference characteristic functions ƒₘ(t) is performed by means of a neural network trained to extract information about textures, shadows, reflections or other sources of information about the segmented part in the image and wherein f(t) and/or fₘ(t) is at least one output of the neural network.

Alternative to the use of the contour, other characteristics of the part and/or of the parts which are represented by the models can be used to generate the characteristic function ƒ(t) and/or the reference characteristic functions ƒₘ(t); for example, the texture, shadows, and reflections.

The processor generates such functions using a neural network, wherein one of the outputs of said neural network is the characteristic function ƒ(t) and/or one of the reference characteristic functions ƒₘ(t).

In one embodiment, the degree of proximity resulting from the comparison between two characteristic functions (f(t), fₘ(t+φ)), wherein φ is an offset value, is determined as the minimum distance between both functions, with φ taking any offset value φ.

Due to the nature of the definition of the characteristic function ƒ(t) based on its contour, this function is periodic. This gives rise to the fact that a subsequent search on the degree of similarity between two periodic functions for any value among the possible angles makes the comparison invariable with respect to the initial point in the boundary curve that defines the contour for defining the characteristic function ƒ(t).

In one embodiment, the distance between two functions is determined as the norm of the difference of the two functions, for a pre-established norm.

In these embodiments, the degree of proximity is estimated by calculating the minimum distance between the characteristic function ƒ(t) and each of the reference characteristic functions ƒₘ(t) or calculating the norm of the difference between said functions.

In other embodiments, other metrics for estimating the degree of proximity or similarity between functions are valid in the context of the invention.

In one embodiment, the selected angles are two angles different from one another and different from the angle of rotation about the optical axis of the camera.

This specific angle selection allow the results to be invariable with respect to the angle of rotation about the optical axis of the camera, and therefore enable operation with two-dimensional domains instead of three-dimensional domains, resulting in a lower computing cost.

In one embodiment, the representative model of the shape of the part is:
either a numerical model and step iv), in which an image of the model is generated for each established orientation, is performed by means of rendering the numerical model oriented according to the established orientation,
or a physical part and step iv), in which an image of the model is generated for each established orientation, is performed by capturing an image by means of a camera, wherein the part has an orientation with respect to the camera according to the established orientation.

Each of the models representing parts with a known geometry or shape can be generated in a simulated manner by means of a numerical model or in a real manner by using physical parts.

Said models require the generation of a plurality of images of the part that they represent. In the case of using a numerical model, the images are generated by means of rendering said numerical model oriented according to the required orientation by simulating a scenario in which the model is located and the camera has the same intrinsic and extrinsic parameters as the real camera. In contrast, if real physical parts are used, the images are captured by means of a camera by orienting the real part with respect to the camera according to the required orientation.

In one embodiment, the processor is configured to rotate, in step f), the scalar functions gⱼ by applying a transformation matrix on each of said scalar functions gⱼ, wherein each transformation matrix is defined by the positions and orientations of the reference camera Cᵢ and of the camera Cⱼ.

The rotation of the scalar functions gⱼ prior to the merging thereof is performed in accordance with a transformation matrix. The processor defines this matrix based on the known positions and orientations of the reference camera Cᵢ and of the camera Cⱼ (that is, the camera corresponding to the scalar function to be rotated).

In one embodiment, the device has stored therein the positions and orientations of the cameras as a result of a prior calibration process.

In one embodiment, if only the transformation matrix is used to rotate the scalar functions, it is assumed that the center of the part is located in the center of the captured image.

In one embodiment, the processor is configured to apply, in step f), a shift on each scalar function gⱼ before or after applying the transformation matrix.

Given a scalar function gᵢ before the transformation, the transformation provides the value of gⱼ depending on the angles of the domain thereof, such that they verify that they are the values of the function sought at the same angles in the domain before being transformed or rotated.

In this embodiment, the center of the part is not located in the center of the captured image. Therefore, it is necessary to additionally apply this shift to the rotation matrix in order to enable performing the rotation of the scalar functions.

In one embodiment, the n cameras are distributed in a spherical geometric location such that the optical axes of all the cameras are oriented towards an inner region of the sphere, the inner region being configured to house therein the part to be classified and preferably comprising the center of the sphere.

In this embodiment, the cameras are distributed in a closed surface in the form of a sphere, oriented towards an inner region thereof, in which the part to be classified will be housed. This geometric distribution is advantageous to enable viewing the part from different points of view, such that the probabilities of correctly classifying the part into its corresponding model are maximized.

In a particular embodiment, the inner region of the sphere comprises the center of the sphere.

In one embodiment, the n cameras are distributed in a geometric location in the form of a barrel such that the optical axes of all the cameras are oriented towards an inner region of the barrel, the inner region of the barrel being configured to house therein the part to be classified.

In this embodiment, the cameras are distributed in a closed surface in the form of a barrel, oriented towards an inner region thereof, in which the part to be classified will be housed. This geometric distribution is advantageous to enable viewing the part from different points of view, such that the probabilities of correctly classifying the part into its corresponding model are maximized.

Throughout the description, surface in the form of a barrel will be understood to mean a closed surface in the form of a cylinder with two upper and lower bases having an outwards bulge in the central area thereof.

In a particular embodiment, the inner region of the barrel at least partially comprises an axis of the barrel, the axis of the barrel connecting the centers of the upper and lower bases thereof.

Advantageously, since the cameras of the device are distributed in a surface in the form of a barrel, said cameras can point to different points of the axis of the barrel to capture the part during its movement (for example, up-down or down-up on the axis). It is understood that the path of the part essentially follows the axis of the barrel, so it is located in the capture region of a camera at one time or another. The part is thereby always captured on the axis, in a capture location of the camera that has at least that location on the axis in focus, and at the same distance with maximum resolution. That is, even if there are cameras oriented towards different points on the axis, if the part passes through the axis, then at different instants of time the same distance and focus conditions are present in different cameras.

In one embodiment, the merging criterion is one selected from the following list:
for each value of the domain of the scalar function, the merged value is the maximum value of all the scalar functions gⱼ, j=1, . . . , n;
for each value of the domain of the scalar function, the merged value is the sum of the values of each of the scalar functions gⱼ, j=1, . . . , n;
for each value of the domain of the scalar function, the merged value is the value of the norm of the set of n values of the scalar functions gⱼ, j=1, . . . , n.

In this embodiment, different merging criteria are set forth without prejudice to the fact that other different merging criteria are possible in the context of the invention.

In one embodiment, the device further comprises means for placing the part to be classified in the inner region by means of either free fall or a launch.

In this embodiment, Zero Gravity 3D, ZG3D, technology based on a system in which the part falls through the capture space of the cameras so that there is no securing or support element of any type that conceals any portion of the part, is used. This technology is described in patent EP2511653.

Alternatively, the part can be positioned in the capture space of the cameras by using a launcher which likewise allows analyzing the part without of any type of concealment. This technology is described in patent EP3418675.

In this embodiment, the part is placed at different points of the area of interest by moving up-down (if the means for placing the part operate by free fall, like in ZG3D technology explained above) or down-up (if the means for placing the part use a launcher).

With any of these two configurations, the device has the advantage of the part being inspected in its entirety without any of its portions being concealed. The entire part therefore appears in the captured images, without concealment, which maximizes the possibilities of correctly classifying it into its corresponding model.

In other embodiments, the positioning of the part in the capture space of the camera(s) could be performed using any other means.

In a second inventive aspect, the invention provides a method for classifying parts carried out by the device of the first inventive aspect, wherein the method comprises the processor of the device executing the following steps
1) activating the plurality of cameras with each camera Cⱼ capturing an image of the part to be classified;
2) segmenting the images in order to distinguish, in each image, the captured part to be classified from the background;
3) defining a characteristic function ƒ(t), with t being a scalar parameter, of the captured part for each of the segmented images;
4) comparing, for each segmented image, the characteristic function ƒ(t) with a plurality of predefined reference characteristic functions ƒₘ(t) of a representative model of the part to be classified, determining a degree of proximity with each of such characteristic functions ƒₘ(t);
wherein the reference characteristic functions ƒₘ(t) are predefined according to the following steps carried out by the processor:
   i. providing the representative model of the part to be classified;
   ii. selecting a set of orientation angles of the model;
   iii. discretizing a domain formed by all the possible values of the angles selected in the preceding step and, for each point of the discretized domain, orienting the part of the model according to the discrete values of the angles corresponding to that point of the domain;
   iv. generating an image of the model for each orientation established in the preceding step, the image being in accordance with the position and orientation of a camera Cᵢ considered as a reference camera, and executing, for each orientation, steps 2) and 3) to obtain the characteristic function ƒₘ(t);
5) generating, for each camera Cⱼ, j=1, . . . , n, a scalar function gⱼ dependent on at least the angles selected in step ii), the scalar function gⱼ being defined as the degree of proximity between the characteristic function ƒ(t) of the part captured by the camera Cⱼ and the plurality of reference characteristic functions ƒₘ(t), the scalar function gⱼ being determined in the predefined domain for each angle of the selected angles;
6) taking one of the scalar functions gᵢ, the one associated with a predetermined reference camera Cᵢ, as a reference, and rotating the remaining scalar functions gⱼ, i≠j, according to the orientation difference between the reference camera Cᵢ and the camera Cⱼ so that all the scalar functions are representing the degree of proximity with respect to one and the same angle reference;
7) merging the n scalar functions gⱼ into a single scalar function gₐ by means of a pre-established merging criterion;
8) repeating steps 4)-7) for a plurality of representative models of the part to be classified obtaining a plurality of scalar functions gₐ;
9) selecting the model the scalar function gₐ of which exhibits the minimum degree of proximity from among all the degrees of proximity of the plurality of scalar functions gₐ; and
10) classifying the part as corresponding to the model selected in the preceding step.

### DESCRIPTION OF THE DRAWINGS

These and other features and advantages of the invention will become more apparent from the following detailed description of a preferred embodiment, given solely by way of illustrative and non-limiting example in reference to the attached figures.

FIGS. 1a-1b show the device of the invention according to one embodiment.

FIG. 2 shows an example of the steps carried out by the processor of the device of the invention to obtain the characteristic functions ƒ(t) of a part to be classified.

FIG. 3 shows an example of the steps carried out by the processor of the device of the invention to obtain the reference characteristic functions ƒₘ(t) of two reference models.

FIG. 4a-4b show an example of the comparison of the characteristic functions ƒ(t) of the part to be classified and the reference characteristic functions ƒₘ(t) of the models carried out by the processor of the device.

FIG. 5 shows an example of a two-dimensional scalar function g j.

### DETAILED DESCRIPTION OF THE INVENTION

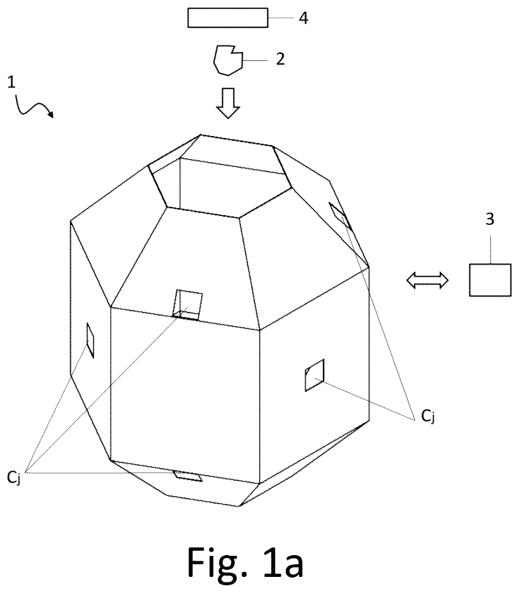

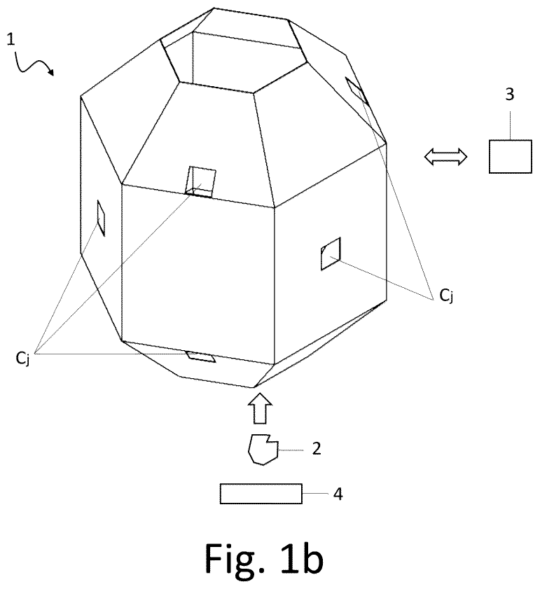

FIGS. 1a-1b shows a device (1) for classifying parts (2), comprising:
a plurality of cameras Cⱼ, j=1, . . . , n, with n being the number of cameras, for capturing images, each of the cameras Cⱼ being configured to capture the part (2) to be classified; wherein the n cameras are distributed in space with a different position and orientation, and
a processor (3) configured to receive the images captured by the plurality of cameras Cⱼ and to process them;
wherein the processor (3) is configured to carry out steps a)-j) described above and to generate the characteristic functions ƒ(t) and the reference characteristic functions ƒₘ(t) according to steps i)-iv) described in detail above.

In FIG. 1a, the n cameras are distributed in a geometric location in the form of a barrel such that the optical axes of all the cameras are oriented towards an inner region of the barrel, the inner region of the barrel being configured to house therein the part (2) to be classified and preferably at least partially comprising an axis of the barrel, the axis of the barrel connecting the centers of the upper and lower bases thereof.

Furthermore, FIG. 1a shows means (4) for placing the part (2) to be classified in the inner region by free fall. These means (4) for placing the part are optional.

FIG. 1b shows the same device as that of FIG. 1a, with the exception that the means (4) place the part (2) to be classified in the inner region by means of launching. These means (4) for placing the part are optional.

In another embodiment that is not shown, the n cameras are distributed in a spherical geometric location such that the optical axes of all the cameras are oriented towards an inner region of the sphere, the inner region being configured to house therein the part (2) to be classified and preferably comprising the center of the sphere. Although the outer casing adopts a polygonal shape, the points where the cameras are located are equidistant with respect to a common central point, and the cameras are therefore located in a spherical geometric location.

In one embodiment, for any of the devices (1) shown in FIGS. 1a-1b, each model in accordance with which the part (2) can be classified is:
either a numerical model and step iv), in which an image of the model is generated for each established orientation, is performed by means of rendering the numerical model oriented according to the established orientation,
or a physical part (2) and step iv), in which an image of the model is generated for each established orientation, is performed by capturing an image by means of a camera, wherein the part (2) has an orientation with respect to the camera according to the established orientation.

The devices (1) shown in FIGS. 1a-1b are further configured to execute a method for classifying parts (2), wherein the method comprises the processor (3) of the device (1) executing steps 1)-10) described above and wherein the processor (3) furthermore generates the characteristic functions ƒ(t) and the reference characteristic functions ƒₘ(t) according to steps i)-iv) described in detail above.

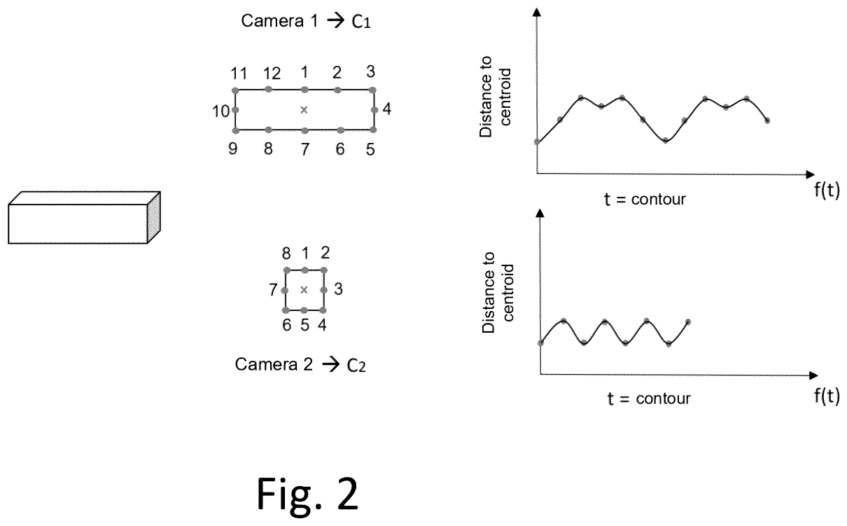

FIG. 2 shows an example of the steps carried out by the processor (3) of the device (1) of the invention to obtain the characteristic functions ƒ(t) of a part (2) to be classified.

In this example, the part (2) is a rectangular prism and the device (1) comprises two cameras, C₁ and C₂, arranged on the same horizontal plane, but with a 90-degree angular difference between them.

The processor (3) activates the cameras (2) C₁ and C₂ so that each of them captures an image of the part (2). Then, the processor segments the images, distinguishing the part (2) from the background in each image. Based on this segmentation, the processor defines a characteristic function ƒ(t) for each of the images by carrying out the following steps:
c.1) establishing a closed path which delimits the contour of the part (2) in each of the segmented images;
c.2) determining a characteristic point of the closed path. In this case, the centroid of the inner area of the closed path shown in FIG. 2 with an X;
c.3) selecting an initial point of the closed path, shown in FIG. 2 with number 1;
c.4) parametrizing the closed path based on the selected initial point; and
c.5) defining the characteristic function ƒ(t) as the function which represents, for each parametrized point t of the closed path (points 1-12 for the image of camera C₁ and points 1-8 for the image of camera C₂), the distance between point t and the centroid.

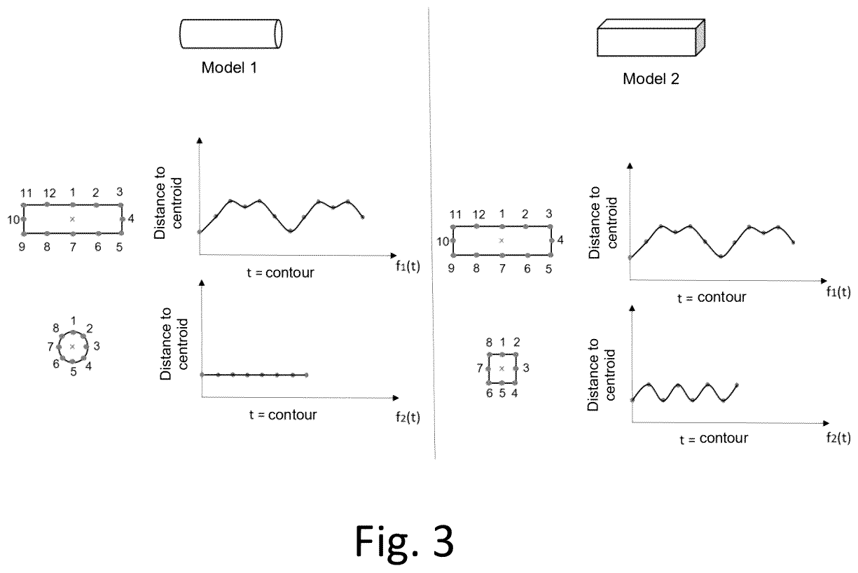

FIG. 3 shows an example of the steps carried out by the processor (3) to generate the reference characteristic functions ƒₘ(t) of two part models with previously known shapes. In this example, the device (1) is the same as that of FIG. 2.

In this case, the processor (3):
i. provides the representative models of the parts with known shapes;
ii. selects a set of orientation angles of the model;
iii. discretizes a domain formed by all the possible values of the angles selected in the preceding step and, for each point of the discretized domain, orients the part (2) of the model according to the discrete values of the angles corresponding to that point of the domain;
iv. generates an image of the model for each orientation established in the preceding step, the image being in accordance with the position and orientation of a camera Cᵢ considered as a reference camera;
v. segments the images in order to distinguish, in each image, the part (2) of the model from the background; and
vi. defines the characteristic functions ƒₘ(t) of the part (2) of the models for each of the segmented images following the same steps c.1)-c.5) described for generating the characteristic function in FIG. 2.

In one embodiment, the selected angles are two angles different from one another and different from the angle of rotation about the optical axis of the camera.

Model 1 represents a part in the form of a cylinder and model 2 represents a part in the form of a rectangular prism.

In both cases, the reference characteristic functions ƒₘ(t) represent the distance between points of the closed paths and the corresponding centroid of the inner area of the closed path.

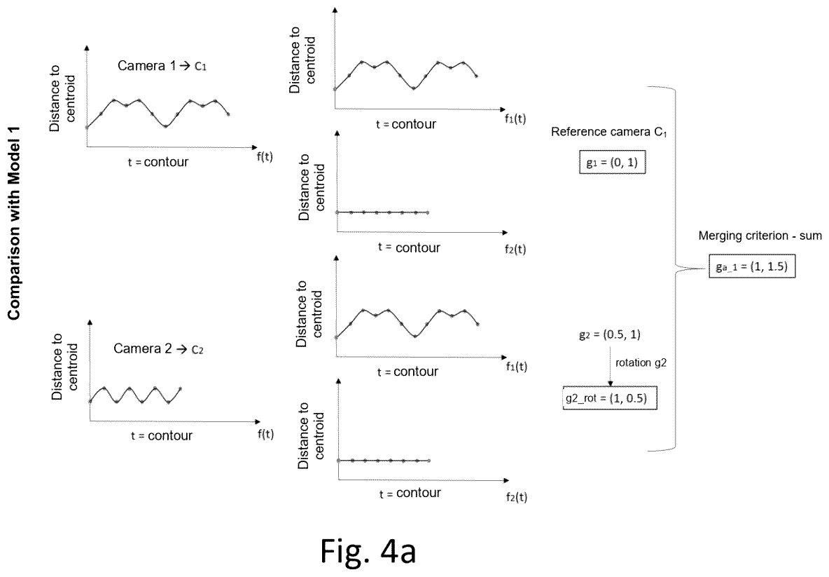

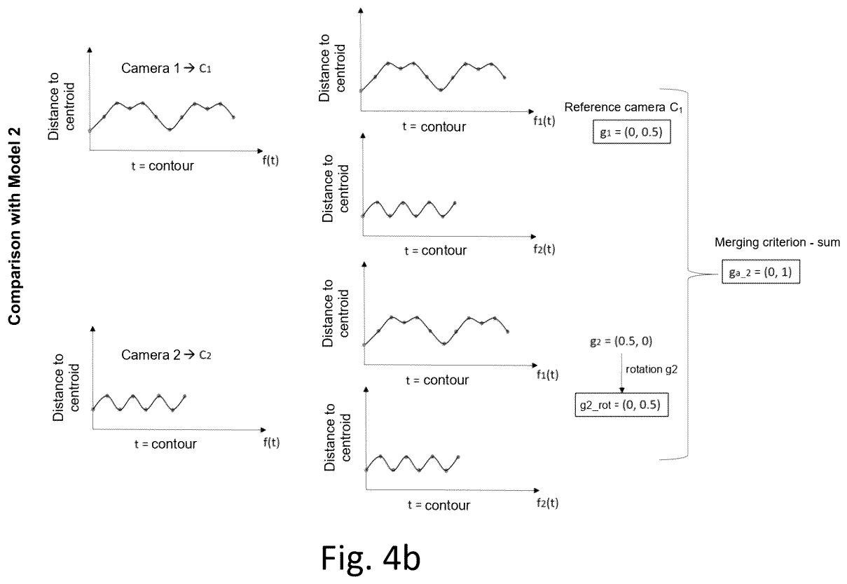

FIG. 4a-4b show an example of the comparison of the characteristic functions ƒ(t) of the part (2) shown in FIG. 2 and the reference characteristic functions ƒₘ(t) of the models shown in FIG. 3, the comparison being carried out by the processor (3) of the device (1) described in FIGS. 2 and 3.

In particular, FIG. 4a shows the comparison between the characteristic functions ƒ(t) of the part (2) and the reference characteristic functions ƒₘ(t) of model 1 and FIG. 4b shows the comparison between the characteristic functions ƒ(t) of the part (2) and the reference characteristic functions ƒₘ(t) of model 2.

The processor (3) compares, for each previously segmented image, the characteristic function ƒ(t) with the reference characteristic functions ƒₘ(t) of the two representative models of the part (2) and determines a degree of proximity with each of such characteristic functions ƒₘ(t).

In the context of the invention, the greater the similarity between the characteristics of the part (2) to be classified and the characteristics of the parts of the models, the smaller the degree of proximity is in terms of measurement. Therefore, if the degree of proximity is zero, it means that the characteristic functions ƒ(t) and fₘ(t) that are being compared are the same and, therefore, the morphology of the part (2) is substantially the same as the morphology of the part of the model.

Based on the estimated degrees of proximity, the processor (3) generates, for each camera C₁ and C₂, a scalar function (g₁ and g₂), being defined as the degree of proximity between the characteristic function of the part (2) captured respectively by camera C₁ and camera C₂, and the plurality of reference characteristic functions ƒₘ(t).

For model 1, the processor (3) estimates that:
The characteristic function ƒ(t) obtained from the segmented image acquired by camera C₁ is substantially the same as the reference characteristic function θ₁(t). Therefore, the degree of proximity is zero.
The characteristic function ƒ(t) obtained from the segmented image acquired by camera C₁ is completely different from the reference characteristic function ƒ₂(t). Therefore, the degree of proximity is equal to one.
The characteristic function ƒ(t) obtained from the segmented image acquired by camera C₂ exhibits certain similarity with the reference characteristic function ƒ₁(t). Therefore, the degree of proximity is equal to 0.5.
The characteristic function ƒ(t) obtained from the segmented image acquired by camera C₂ is completely different from the reference characteristic function ƒ₂(t). Therefore, the degree of proximity is equal to one.

The scalar functions of model 1, g₁ and g₂, are therefore:

$${g}_{1} = ( 0 , 1 )$$

$${g}_{2} = ( 0.5 , 1 )$$

For model 2, the processor (3) estimates that:
The characteristic function ƒ(t) obtained from the segmented image acquired by camera C₁ is substantially the same as the reference characteristic function ƒ₁(t). Therefore, the degree of proximity is zero.
The characteristic function ƒ(t) obtained from the segmented image acquired by camera C₁ exhibits certain similarity with the reference characteristic function ƒ₂(t). Therefore, the degree of proximity is equal to 0.5.
The characteristic function ƒ(t) obtained from the segmented image acquired by camera C₂ exhibits certain similarity with the reference characteristic function ƒ₁(t). Therefore, the degree of proximity is equal to 0.5.
The characteristic function ƒ(t) obtained from the segmented image acquired by camera C₂ is substantially the same as the reference characteristic function ƒ₂(t). Therefore, the degree of proximity is zero.

The scalar functions of model 2, g₁ and g₂, are therefore:

$${g}_{1} = ( 0 , 0 \text{.5} )$$

$${g}_{2} = ( 0.5 , 0 )$$

For each model, the processor (3) takes the scalar function g₁ associated with the camera C₁ as a reference and rotates the scalar function g₂ according to the orientation difference between cameras C₁ and C₂ (90 degrees). This rotation, in this particular example, consists of a shift of the elements of the scalar functions g₂. In this way, all the scalar functions are representing the degree of proximity with respect to one and the same angle reference.

The rotated scalar functions, g₂ rot, for each model are:

$${g}_{2 \_ rot} = ( 1 , 0.5 ) \qquad model 1$$

$${g}_{2 \_ rot} = ( 0 , 0.5 ) \qquad model 2$$

Then, for each model, the processor (3) merges the scalar functions g₁ and g_{2_rot}, obtaining a single scalar function gₐ by means of a pre-established merging criterion. In this case, for each value of the domain of the scalar function, the merged value is the sum of the values of each of the scalar functions g₁ and g₂ rot.

The merged scalar functions of models 1 and 2, gₐ_{₁}, and gₐ_{₂}, are therefore:

$${g}_{{a}_{1}} = ( 1 , 1 \text{.5} )$$

$${g}_{{a}_{2}} = ( 0 , 1 )$$

In other embodiments:
for each value of the domain of the scalar function, the merged value is the maximum value of all the scalar functions gⱼ, j=1, . . . , n;
for each value of the domain of the scalar function, the merged value is the value of the norm of the set of n values of the scalar functions gⱼ, j=1, . . . , n.

The processor (3) selects the model the scalar function gₐ of which exhibits the minimum degree of proximity from among all the degrees of proximity of the plurality of scalar functions gₐ, in this case, model 2, since the merged scalar function gₐ_{₂} exhibits the minimum value from between the two merged scalar functions of the two models of the example.

Finally, the processor (3) classifies the part (2) as corresponding to model 2 selected in the preceding step.

In one embodiment, the degree of proximity resulting from the comparison between two characteristic functions (f(t), fₘ(t+φ)), wherein φ is an offset value, is determined as the minimum distance between both functions, with φ taking any offset value φ.

In one embodiment, the distance between two functions is determined as the norm of the difference of the two functions, for a pre-established norm.

In one embodiment, the processor (3) is further configured to determine the set of angles which determine the minimum of the scalar function gₐ of the selected model such that the orientation for which the scalar function is minimum is the orientation of the part (2).

In one embodiment, if the smallest degree of proximity is greater than a pre-established threshold value, then it is considered that the part (2) to be classified does not correspond to any model.

In another embodiment different from that shown in the preceding figures, the processor (3) defines the characteristic function ƒ(t) and/or the reference characteristic functions ƒₘ(t) by means of a neural network trained to extract information about textures, shadows, reflections or other sources of information about the segmented part (2) in the image, with f(t) and/or fₘ(t) being at least one output of the neural network.

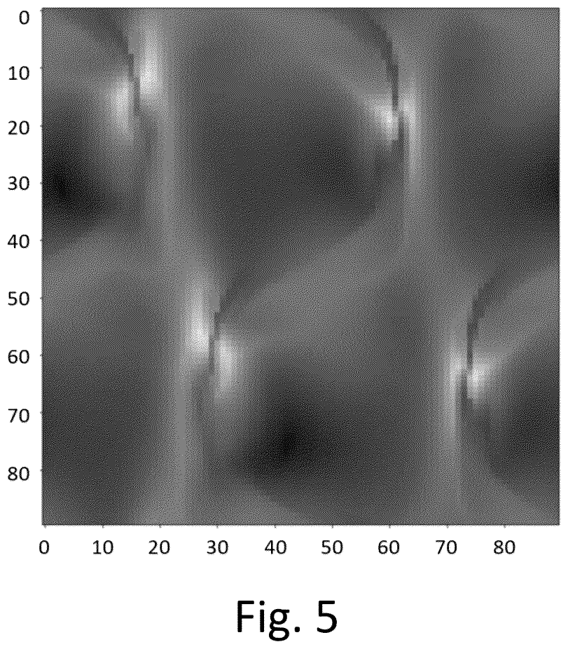

For the sake of simplicity, the device (1) comprising only two cameras located on one and the same horizontal plane is contemplated in the preceding examples, so the scalar functions gⱼ which define the degrees of proximity are vectors. FIG. 5 shows a more complex example of a two-dimensional scalar function gⱼ in grayscale, wherein the distance between a characteristic function ƒ(t) and the plurality of reference characteristic functions ƒₘ(t) of a particular model is coded in colors ranging from black to white (with black being the minimum distance or minimum degree of proximity and white being the maximum distance or maximum degree of proximity). The axes represent the rotation of the part (2) to be classified with respect to a predefined position of the model being compared in the horizontal and vertical coordinate axes.

For each model, a two-dimensional scalar function gⱼ in grayscale will be obtained for each characteristic function of the part (2) to be classified.

In one embodiment, the processor (3) is configured to rotate, in step f), the scalar functions gⱼ by applying a transformation matrix on each of said scalar functions gⱼ, wherein each transformation matrix is defined by the positions and orientations of the reference camera Cᵢ and of the camera Cⱼ.

In one embodiment, the processor (3) is configured to apply, in step f), a shift on each scalar function gⱼ before or after applying the transformation matrix.

1. A device for classifying parts, comprising:
a plurality of cameras Cⱼ, j=1, . . . , n, with n being the number of cameras, for capturing images, each camera of the plurality of cameras Cⱼ being configured to capture the part to be classified, wherein the n cameras are distributed in space with a different position and orientation; and
a processor configured to receive the images captured by the plurality of cameras Cⱼ and to process them,
wherein the processor is further configured to carry out the following steps:
a) activating the plurality of cameras with each camera Cⱼ capturing an image of the part to be classified;
b) segmenting the images in order to distinguish, in each image, the captured part to be classified from the background;
c) defining a characteristic function ƒ(t), with t being a scalar parameter, of the captured part for each of the segmented images;
d) comparing, for each segmented image, the characteristic function ƒ(t) with a plurality of predefined reference characteristic functions ƒₘ(t) of a representative model of the part to be classified, determining a degree of proximity with each of such characteristic functions ƒₘ(t);
wherein the reference characteristic functions ƒₘ(t) are predefined according to the following steps:
i. providing the representative model of the part to be classified;
ii. selecting a set of orientation angles of the model;
iii. discretizing a domain formed by all the possible values of the angles selected in the preceding step and, for each point of the discretized domain, orienting the part of the model according to the discrete values of the angles corresponding to that point of the domain;
iv. generating an image of the model for each orientation established in the preceding step, the image being in accordance with the position and orientation of a camera Cᵢ considered as a reference camera, and executing, for each orientation, steps b) and c) to obtain the characteristic function ƒₘ(t);
and wherein the processor is further configured to:
e) generate, for each camera Cⱼ, j=1, . . . , n, a scalar function gⱼ dependent on at least the angles selected in step ii), the scalar function gⱼ being defined as the degree of proximity between the characteristic function ƒ(t) of the part captured by the camera Cⱼ and the plurality of reference characteristic functions ƒₘ(t), the scalar function gⱼ being determined in the predefined domain for each angle of the selected angles;
f) take one of the scalar functions gᵢ, the one associated with a predetermined reference camera Cᵢ, as a reference, and rotating the remaining scalar functions gⱼ, i≠j, according to the orientation difference between the reference camera Cᵢ and the camera Cⱼ so that all the scalar functions are representing the degree of proximity with respect to one and the same angle reference;
g) merge the n scalar functions gⱼ into a single scalar function gₐ by means of a pre-established merging criterion;
h) repeat steps d)-g) for a plurality of representative models of the part to be classified obtaining a plurality of scalar functions gₐ;
i) select the model the scalar function gₐ of which exhibits the minimum degree of proximity from among all the degrees of proximity of the plurality of scalar functions gₐ; and
j) classify the part as corresponding to the model selected in the preceding step.

2. The device according to claim 1, wherein the processor is further configured to determine the set of angles which determine the minimum of the scalar function gₐ of the selected model such that the orientation for which the scalar function is minimum is the orientation of the part.

3. The device according to claim 1, wherein if the smallest degree of proximity is greater than a pre-established threshold value, then it is considered that the part to be classified does not correspond to any model.

4. The device according to claim 1, wherein step c) of defining the characteristic function ƒ(t) and/or the reference characteristic functions ƒₘ(t) comprises the following sub-steps:
c.1) establishing a closed path which delimits the contour of the part in each of the segmented images;
c.2) determining a characteristic point of the closed path, preferably the centroid of the inner area of the closed path;
c.3) selecting an initial point of the closed path;
c.4) parametrizing the closed path based on the selected initial point; and
c.5) defining the characteristic function ƒ(t) or the reference characteristic function ƒₘ(t) as the function which represents, for each parametrized point t of the closed path, the distance between point t and the characteristic point.

5. The device according to claim 1, wherein step c) of defining the characteristic function ƒ(t) and/or the reference characteristic functions ƒₘ(t) is performed by means of a neural network trained to extract information about textures, shadows, reflections or other sources of information about the segmented part in the image, and wherein f(t) and/or fₘ(t) is at least one output of the neural network.

6. The device according to claim 1, wherein the degree of proximity resulting from the comparison between two characteristic functions (f(t), fₘ(t++)), wherein φ is an offset value, is determined as the minimum distance between both functions, with φ taking any offset value φ.

7. The device according to claim 6, wherein the distance between two functions is determined as the norm of the difference of the two functions, for a pre-established norm.

8. The device according to claim 1, wherein the selected angles are two angles different from one another and different from the angle of rotation about the optical axis of the camera.

9. The device according to claim 1, wherein the representative model of the shape of the part is either a numerical model and step iv), in which an image of the model is generated for each established orientation, is performed by means of rendering the numerical model oriented according to the established orientation or a physical part and step iv), in which an image of the model is generated for each established orientation, is performed by capturing an image by means of a camera, wherein the part has an orientation with respect to the camera according to the established orientation.

10. The device according to claim 1, wherein the processor is configured to rotate, in step f), the scalar functions gⱼ by applying a transformation matrix on each of said scalar functions gᵢ, wherein each transformation matrix is defined by the positions and orientations of the reference camera Cᵢ and the camera Cⱼ.

11. The device according to claim 10, wherein the processor is configured to apply, in step f), a shift on each scalar function gⱼ before or after applying the transformation matrix.

12. The device according to claim 1, wherein the n cameras of the plurality of cameras are distributed either in a spherical geometric location such that the optical axes of the plurality of cameras are oriented towards an inner region of the sphere, the inner region being configured to house therein the part to be classified and preferably comprising the center of the sphere or in a geometric location in the form of a barrel such that the optical axes of the plurality of cameras are oriented towards an inner region of the barrel, the inner region of the barrel being configured to house therein the part to be classified and preferably at least partially comprising an axis of the barrel, the axis of the barrel connecting the centers of the upper and lower bases thereof.

13. The device according to claim 1, wherein the merging criterion is one selected from the following list:
for each value of the domain of the scalar function, the merged value is the maximum value of all the scalar functions gⱼ, j=1, . . . , n;
for each value of the domain of the scalar function, the merged value is the sum of the values of each of the scalar functions gⱼ, j=1, . . . , n; or
for each value of the domain of the scalar function, the merged value is the value of the norm of the set of n values of the scalar functions gⱼ, j=1, . . . , n.

14. The device according to claim 1, further comprising means for placing the part to be classified in the inner region by means of either free fall or a launch.

15. A method for classifying parts carried out by the device according to claim 1, wherein the method comprises the processor of the device executing the following steps
1) activating the plurality of cameras with each camera Cⱼ capturing an image of the part to be classified;
2) segmenting the images in order to distinguish, in each image, the captured part to be classified from the background;
3) defining a characteristic function ƒ(t), with t being a scalar parameter, of the captured part for each of the segmented images;
4) comparing, for each segmented image, the characteristic function ƒ(t) with a plurality of predefined reference characteristic functions ƒₘ(t) of a representative model of the part to be classified, determining a degree of proximity with each of such characteristic functions ƒₘ(t);
wherein the reference characteristic functions ƒₘ(t) are predefined according to the following steps carried out by the processor:
i. providing the representative model of the part to be classified;
ii. selecting a set of orientation angles of the model;
iii. discretizing a domain formed by all the possible values of the angles selected in the preceding step and, for each point of the discretized domain, orienting the part of the model according to the discrete values of the angles corresponding to that point of the domain;
iv. generating an image of the model for each orientation established in the preceding step, the image being in accordance with the position and orientation of a camera Cᵢ considered as a reference camera, and executing, for each orientation, steps 2) and 3) to obtain the characteristic function ƒₘ(t);
5) generating, for each camera Cⱼ, j=1, . . . , n, a scalar function gⱼ dependent on at least the angles selected in step ii), the scalar function gⱼ being defined as the degree of proximity between the characteristic function ƒⱼ(t) of the part captured by the camera Cⱼ and the plurality of reference characteristic functions ƒₘ(t), the scalar function gⱼ being determined in the predefined domain for each angle of the selected angles;
6) taking one of the scalar functions gᵢ, the one associated with a predetermined reference camera Cᵢ, as a reference, and rotating the remaining scalar functions gⱼ, i≠j, according to the orientation difference between the reference camera Cᵢ and the camera Cᵢ so that all the scalar functions are representing the degree of proximity with respect to one and the same angle reference;
7) merging the n scalar functions gⱼ into a single scalar function gₐ by means of a pre-established merging criterion;
8) repeating steps 4)-7) for a plurality of representative models of the part to be classified obtaining a plurality of scalar functions gₐ;
9) selecting the model the scalar function gₐ of which exhibits the minimum degree of proximity from among all the degrees of proximity of the plurality of scalar functions gₐ; and
10) classifying the part as corresponding to the model selected in the preceding step.
